(19) United States
(12) Patent Application Publication
(10) Pub. No.: US 2021/0349264 A1
(43) Pub. Date: Nov. 11, 2021

(54) INTEGRATED OPTICAL DEVICE BASED ON COUPLING BETWEEN OPTICAL CHIPS

(71) Applicant: COMMSCOPE TECHNOLOGIES LLC, Hickory, NC (US)

(72) Inventors: Jan WATTÉ, Grimbergen (BE); Cristina LERMA ARCE, Destelbergen (BE); Salvatore TUCCIO, Kessel-Lo (BE); Saurav KUMAR, Kessel-Lo (BE); Vivek PANAPAKKAM VENKATESAN, Leuven (BE)

(73) Assignee: COMMSCOPE TECHNOLOGIES LLC, Hickory, NC (US)

(21) Appl. No.: 17/282,645

(22) PCT Filed: Oct. 4, 2019
(86) PCT No.: PCT/US2019/054732

§ 371 Date: Apr. 2, 2021

Related U.S. Application Data
(60) Provisional application No. 62/741,918, filed on Oct. 5, 2018.

(51) Int. Cl. G02B 6/26; H04Q 11/00

(52) U.S. Cl. CPC G02B 6/26; H04Q 2011/0015; H04Q 2011/0016; H04Q 11/0005

(57) ABSTRACT

Optical devices a formed by mounting one optical chip directly to another. In some embodiments, one of the optical chips is formed in a low index contrast platform while the other is formed in a high index contrast platform. In other embodiments, one optical chip includes a number of optical functional elements having different operational characteristics, such as a number of optical taps having different tap ratios. A second chip is mounted to receive an optical signal from an optical functional element having a selected operational characteristic.

### CROSS-REFERENCE TO RELATED APPLICATION

This application is being filed on Oct. 4, 2019 as a PCT International Patent Application and claims the benefit of U.S. Patent Application Ser. No. 62/741,918, filed on Oct. 5, 2018, the disclosure of which is incorporated herein by reference in its entirety.

### FIELD OF THE INVENTION

The present invention is generally directed to optical communications, and more specifically to optical devices that include multiple optical chips with direct optical coupling between the chips.

### BACKGROUND OF THE INVENTION

Passive optical networks are becoming prevalent in part because service providers want to deliver high bandwidth communication capabilities to customers. Passive optical networks are a desirable choice for delivering high-speed communication data because they may not employ active electronic devices, such as amplifiers and repeaters, between a central office and a subscriber termination. The absence of active electronic devices may decrease network complexity and/or cost and may increase network reliability.

FIG. 1 illustrates one embodiment of a network 100 deploying fiber optic lines. In the illustrated embodiment, the network 100 can include a central office 101 that connects a number of end subscribers 105 (also called end users 105 herein) in a network. The central office 101 can additionally connect to a larger network such as the Internet (not shown) and a public switched telephone network (PSTN). The network 100 can also include fiber distribution hubs (FDHs) 103 that distribute signals to the end users 105. The various lines of the network 100 can be aerial or housed within underground conduits.

The portion of the network 100 that is closest to central office 101 is generally referred to as the F1 region, where F1 is the “feeder fiber” from the central office 101. The portion of the network 100 closest to the end users 105 can be referred to as an F2 portion of network 100. The network 100 includes a plurality of break-out locations 102 at which branch cables are separated out from the main cable lines. Branch cables are often connected to drop terminals 104 that include connector interfaces for facilitating coupling of the fibers of the branch cables to a plurality of different subscriber locations 105.

An incoming signal is received from the central office 101, and is then typically split at the FDH 103, using one or more optical splitters (e.g., 1×8 splitters, 1×16 splitters, or 1×32 splitters) to generate different user signals that are directed to the individual end users 105. In typical applications, an optical splitter is provided prepackaged in an optical splitter module housing and provided with a splitter output in pigtails that extend from the module. The optical splitter module provides protective packaging for the optical splitter components in the housing and thus provides for easy handling for otherwise fragile splitter components. This modular approach allows optical splitter modules to be added incrementally to FDHs 103 as required.

It is desirable, however, to apportion the optical power output from the central office 101 equally among all users, which means that the optical splitter modules located closer to the central office 101 split off a smaller fraction of the incoming optical signal because the optical signal is strong, while optical splitter modules located further from the central office 101 split off a greater fraction of the incoming optical signal. The fraction of the optical signal split off from the main optical signal is referred to as the tapping fraction. For example, as shown in FIG. 2A, a central office 202, that includes a laser transmitter system 202a and laser receiver system 202b, distributes an optical signal to four users 204 in an optical network 206 via serially arranged asymmetric splitter modules 208. The laser transmitter system 202a may include one or more lasers producing optical signals at different wavelengths, which are multiplexed together, for example via wavelength division multiplexing (WDM) for transmission along the optical network 206. Similarly, the laser receiver system 202b may include one or more optical detectors that receive optical signals at different wavelengths. For example, after receiving a WDM optical signal from the optical network 206, the laser receiver system 202b may demultiplex the WDM signal and detect the optical signals at different wavelengths separately from each other.

To achieve an equal distribution of optical power among the four users 204, the optical tap modules 208a, 208b, 208c respectively split off ¼, ⅓ and ½ of the incident optical power. In other words, the tapping fractions of the splitter modules 208a, 208b and 208c are respectively ¼, ⅓ and ½. The optical splitter modules 208 each split off a fixed fraction of the incident optical power.

In another embodiment, schematically illustrated in FIG. 2B, each tap module 208 supplies at least two users 204. Thus, the first tap module 208a taps 25% of the incoming signal and then splits it into two equal components of 12.5% each, which are directed to users 204. Likewise, the second tap module 208b taps 33.3% of the incoming optical signal and splits it into two equal components of 16.7% each, which are directed to users 204. Finally, the third tap module taps 50% of the incoming signal and splits it into two equal components of 25% each, which are directed to users 204. The other output from the last tap module 208c is also split into two equal components of 25% each, which are directed to users 204. In this manner, each user 204 receives the same fraction of the original optical signal, 12.5%. In this embodiment, each tap module 208 includes not only an optical tap, but also an optical splitter.

Thus, the technician installing the optical tap modules must be supplied with a variety of optical tap modules, that tap different fractions of the incident optical signal, depending on where the network the tap module is to be located. Furthermore, the larger the number of tap modules placed serially along the network, the greater the number of different tap modules that needs to be carried in inventory.

There is a need, therefore, to simplify the process of making optical splitter modules to reduce the numbers of types of optical splitter modules required to be carried in inventory.

### SUMMARY OF THE INVENTION

One embodiment of the present invention is directed to an optical device that has a first optical chip having at least a first optical tap and a second optical tap. Each optical tap comprises an input waveguide, a main output waveguide and a tap waveguide. The first optical tap has a first tap ratio and the second optical tap has a second tap ratio. The second tap ratio is different from the first tap ratio. A second optical chip has an input waveguide coupled to a waveguide splitter network having a plurality of splitter output waveguides. The first and second optical chips are coupled together, the input waveguide of the second optical chip being coupled to receive an optical signal from one of the tap waveguides of the first optical chip.

Another embodiment of the present invention is directed to an optical device that includes a plurality of optical chips. A first optical chip has at least a first input waveguide and at least a first output waveguide. A second optical chip has at least a second input waveguide and at least a second output waveguide. The at least a second input waveguide of the second optical chip is coupled to receive an optical signal from the at least a first output waveguide of the first optical chip. Wherein one of the first and second optical chips is formed in a high index contrast platform and the other of the first and second optical chips is formed in a low index contrast platform.

Another embodiment of the invention is a method of forming an optical device that includes a first optical chip having a plurality of first optical functional elements having different operational characteristics, each first optical functional element having at least a first input waveguide and a first output waveguide. A second optical chip is provided, the second chip having a second optical functional element having at least a second input waveguide and at least a second output. One of the first optical functional elements of the first optical chip is selected. The at least a second input waveguide of the second optical chip is aligned to the at least a first output waveguide of the selected first optical element. The first and second optical chips are mounted so as to maintain the alignment of the at least a second input waveguide of the second optical chip to the at least a first output waveguide of the selected first optical element.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates various elements of an optical data distribution and communication network;

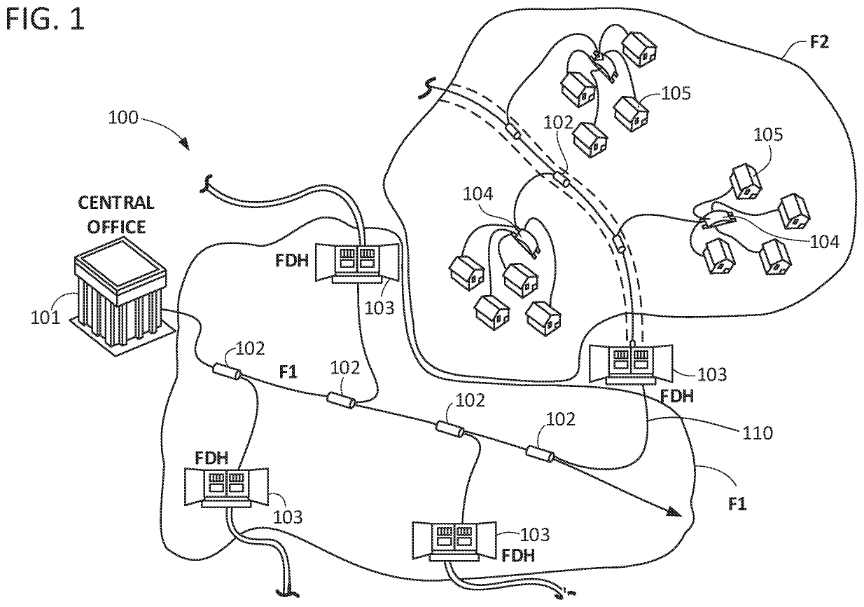

FIG. 2A schematically illustrates a simple, serial optical network having four users and the different optical tap modules required to provide optical signals of equal magnitude to each user;

FIG. 2B schematically illustrates a simple, serial optical network having eight users fed by three optical tap modules that each include a tap function and a splitter function, to provide optical signals of equal magnitude to each user according to an embodiment of the present invention;

FIG. 3 schematically illustrates an embodiment of a coupled-chip optical device in which the first optical chip provides a tap and the second optical chip provides a splitter assembly, according to an embodiment of the present invention;

FIG. 4 schematically illustrates an embodiment of an optical chip having tap outputs of various tap ratios, according to an embodiment of the present invention;

FIG. 5A schematically illustrates an embodiment of an optical chip having a 1:8 splitter assembly that is diceable in a manner that permits the splitter assembly to have a selectable splitting ratio, according to an embodiment of the present invention;

FIG. 5B schematically illustrates an embodiment of an optical chip having 1:4 splitter assembly fabricated from the optical chip shown in FIG. 5A, according to an embodiment of the present invention;

FIG. 5C schematically illustrates an embodiment of an optical chip having a 1:2 splitter assembly fabricated from the optical chip shown in FIG. 5A, according to an embodiment of the present invention;

FIG. 5D schematically illustrates an embodiment of an optical chip having two 1:8 splitter assemblies that is diceable in a manner that permits the splitter assemblies to have selectable splitting ratios, according to an embodiment of the present invention;

FIG. 6 schematically illustrates a coupled-chip optical device formed from the optical chips illustrated in FIGS. 4 and 5A, according to an embodiment of the present invention;

FIG. 7 schematically illustrates the coupled-chip optical device of FIG. 6 enclosed in a housing and optical fibers arranged to couple light signals to and from the coupled-chip optical device, according to an embodiment of the present invention;

FIG. 8 schematically illustrates a three chip, hybrid coupled-chip optical device having a first chip that performs a first optical function, a second chip that performs second optical function and a third chip that performs third optical function, in which the first optical function is wavelength division demultiplexing, the second optical function is switching and the third optical function is wavelength division multiplexing, according to an embodiment of the present invention;

FIG. 9 schematically illustrates a two chip, hybrid coupled-chip optical device having a first chip that performs a first optical function and a second chip that performs a second optical function, according to an embodiment of the present invention;

FIG. 10 schematically illustrates a two chip, hybrid coupled-chip optical device having a first chip that performs a first optical function and a second chip that performs a second optical function, in a housing and connected to optical fibers arranged to couple light signals to and from the coupled-chip device, according to an embodiment of the present invention; and

FIGS. 11A-11C schematically illustrate various stages in the fabrication of a coupled-chip optical device.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is directed to providing optical circuits that are adjustable and that can take advantage of preferred manufacturing in different planar lightwave circuit (PLC) platforms.

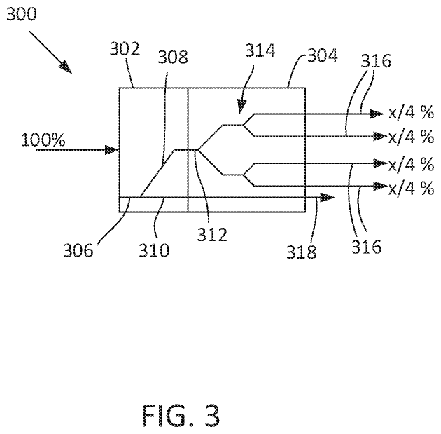

FIG. 3 schematically illustrates an embodiment of a coupled-chip optical device 300 that includes two optical chips 302, 304, where the light is coupled directly from the first chip 302 to the second chip 304. The first optical chip 302 is a tap chip, having an input waveguide 306 that splits to a tap output waveguide 308 and a main output waveguide 310. While the percentage of light that is directed from the input waveguide 306 to the tap output waveguide 308 is not limited, in many applications the tap output waveguide 308 receives less than half of the optical power in the input waveguide 306. Thus, if the optical signal entering the input waveguide 306 is taken as 100%, then the amount of power in the tap output waveguide, x % is typically less than 50%, and in many cases less than 34% of the input optical signal, i.e. x<50, and in many cases x<34%. The amount of light entering the tap waveguide 308 may be low, for example as low as 1%, or even lower depending on the application.

The first optical chip 302 may be formed using any suitable optical waveguide technology, such as planar lightwave circuit (PLC). Waveguide systems are often defined by their refractive index contrast, which is given by (n_{c}²-n_{cl}²)/(2n_{c}²). The refractive index contrast is usually presented as a percentage. For example, in some embodiments, waveguide structures are formed by doping in silica (silicon dioxide) and typically have a refractive index contrast less than 0.4% and, in many embodiments, have a refractive index contrast of around 0.1%. This type of waveguide structure, where the optical mode typically matches directly to the optical mode of a silica fiber, is referred to as a low index contrast structure. Other embodiments of waveguides can have a higher contrast ratio. For example, a waveguide formed in silicon (Si, n_{c}=3.44 at 1550 nm) may have a contrast of around 35% when the cladding is silica (n_{cl}=1.44 at 1550 nm), while a silicon nitride (SiN) waveguide (n_{c}=1.99 at 1550 nm) may have a contrast of around 25%. Also, silica waveguides doped with a relatively high atomic number atom, such as titanium, can have a contrast ratio of 1.35%. Typically, high index contrast waveguides require matching of the optical mode field between the waveguide and a silica optical fiber, for example via a mode spot converter such as a waveguide taper. In general, refractive index contrast ratios less than 1% are considered low and while those above 1% are considered high.

The second optical chip 304 includes a 1:X splitter. In the illustrated embodiment, the second optical chip 304 includes a 1:4 splitter. The second optical chip 304 includes an input waveguide 312 coupled to the tap output waveguide 308 of the first chip. The input waveguide 312 leads to a 1:4 splitter network 314. There are four tap output waveguides 316 from the splitter network 314. In the illustrated embodiment, each split in the splitter section is a 50:50 split, so that each output tap waveguide 316 carries 25% of the tapped optical signal that enters the input waveguide 312, i.e. x/4%, where x % is the tapped optical signal. The second chip 304 may also include a main signal waveguide 318 that is coupled to receive the optical signal from the main output waveguide 310 of the first optical chip 302.

Like the first optical chip 302, the second optical chip 304 may be formed in a low index contrast platform, or in a high index contrast platform. The second optical chip 304 may include a different number of output waveguides, for example using a 1:2, 1:8, 1:16 splitter or the like. In other embodiments, the splitter section 314 of the second optical chip may direct different fractions of the input signal to respective output waveguides 316, in which case the magnitude of the signal at one or more of the output waveguide 316 may be different from the magnitudes of the optical signals at the other output waveguides 316.

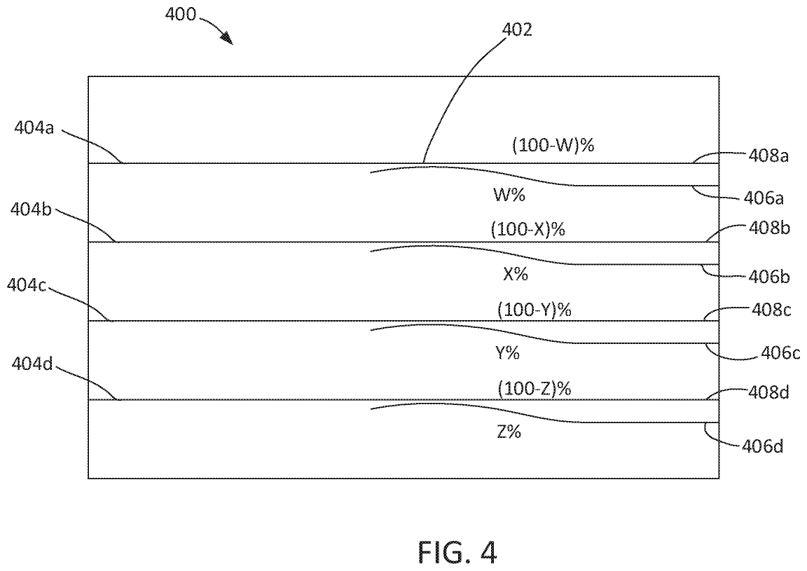

One approach to manufacturing a hybrid coupled-chip optical device is now described with reference to FIGS. 4-6. Under this approach, a first optical chip incorporates a number of similar optical functional elements, each one having different operational characteristics. The first chip has different input waveguides, each associated with a different fraction of light that is tapped into the tap output waveguide. A second optical chip includes a splitter network having a selectable splitter ratio.

Turning first to FIG. 4, a PLC tap chip 400 contains a number of similar optical functional elements having different operational characteristics. More specifically, the tap chip 400 includes a number of integrated broadband, asymmetric optical taps, which are similar functional elements. The optical taps have different operational characteristics in that they have different tap ratios. The optical taps are formed as waveguides on a substrate. As discussed above, the chip 400 may be formed using low refractive index contrast waveguides, for example a silica waveguide, or may be formed using high refractive index contrast waveguides. Each optical tap 402 comprises an input waveguide 404, a tap waveguide 406 and a main output waveguide 408. The tap ratio is the fraction of incoming light that is coupled from the input waveguide to the tap waveguide, and is no more than 50%. The remainder of the light propagates along the main output waveguide 308.

In the illustrated embodiment there are four optical taps 402a-402d, with respective input waveguides 404a-404d, tap waveguide 406a-406d and main output waveguides 408a-408d. Each tap 402 has a different tap ratio. For example, the first tap waveguide 406a may carry W % of the signal propagating along the input waveguide 404A, while the second tap waveguide 406b carries X % of the optical signal propagating along the second input waveguide 404b, the third tap waveguide 406c carries Y % of the optical signal propagating along the third input waveguide 404c and the fourth tap waveguide 406d carries Z % of the optical signal propagating along the fourth input waveguide 404d, where W, X, Y and Z are all different. For example, in some embodiments, W<X<Y<Z.

The broadband tap 402 may be designed to tap a fraction of light from the input waveguide. If the chip 400 covers a sufficiently broad range of tap fractions, the different taps 402 may include different designs. For example, in some embodiments, the taps 402 may include adiabatic couplers, or other types of coupler, to tap a desired percentage of light from the input waveguide 404a-404d.

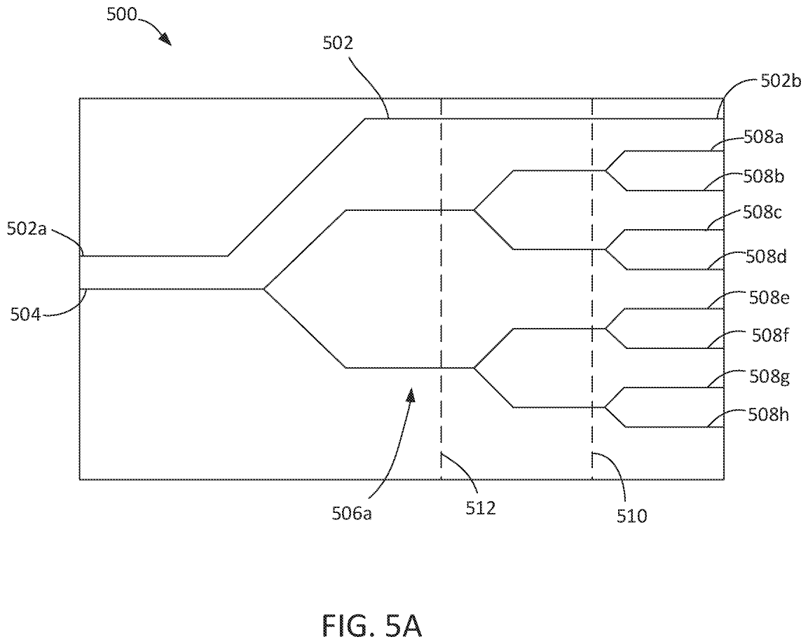

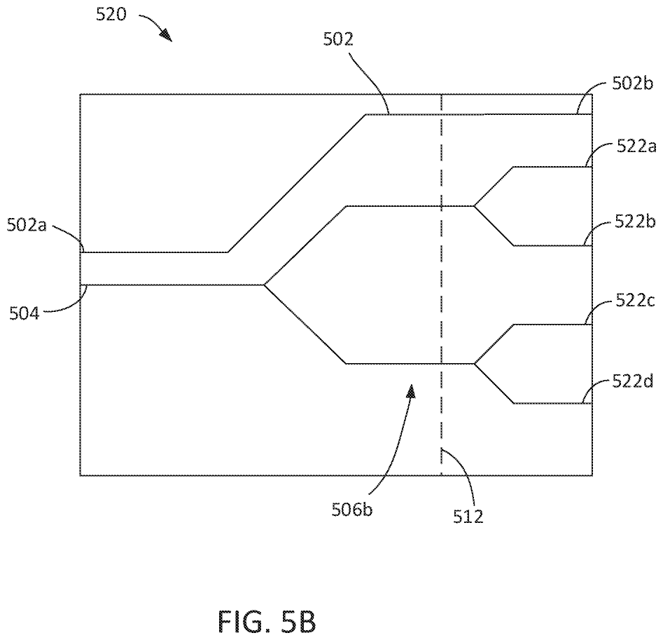

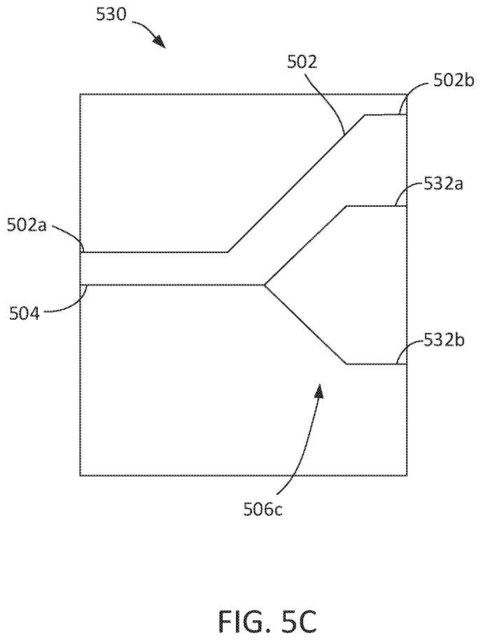

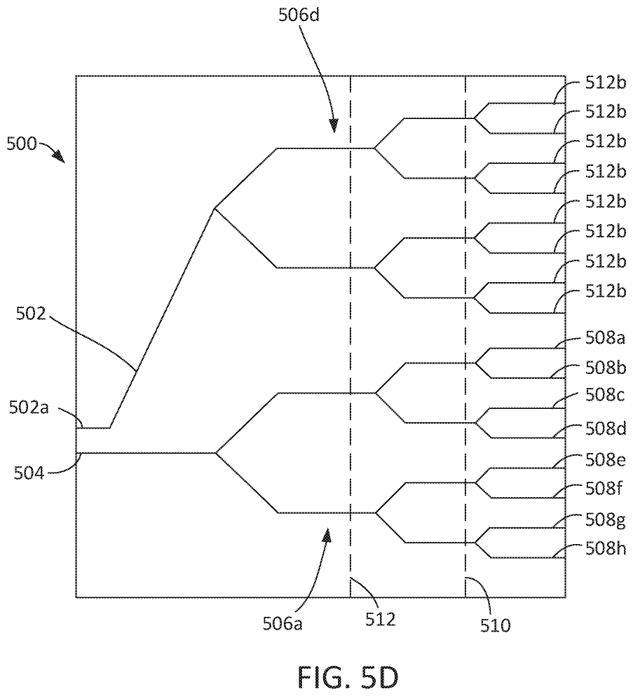

FIG. 5A schematically illustrates a second optical chip 500 that includes a bypass waveguide 502 that has an input 502a at one side of the chip 500 and an output 502b at a second side of the chip 500. The chip 500 also includes an input waveguide 504 that is connected to a splitter network 506a. In the illustrated embodiment, the splitter network 506a is a 1:8 splitter network, having output waveguides 508a-508h. The chip 500 may include a splitter network that splits the incoming signal into a different number of signals, for example a 1:16 or 1:32 splitter.

The chip 500 may be processed to reduce the splitting ratio. For example, the chip 500 may be cleaved along line 510 using precision dicing to produce the cleaved chip 520 illustrated in FIG. 5B. The diced chip 520 has a 1:4 splitter network 506b, with output waveguides 522a-522d. Additionally, the chip 500 may be processed to reduce the splitting ratio by a different amount. For example, the chip 500 may be cleaved along line 512 using precision dicing to produce the diced chip 530 illustrated in FIG. 5C. In this case, the diced chip has a 1:2 splitter network 506c, with output waveguides 532a and 532b.

The chip 500 may be formed in a low index contrast platform, or in a high index contrast platform. In other embodiments, the splitter section of the second optical chip 500 may direct different fractions of the input signal to respective output waveguides, rather than the same fraction, in which case the magnitude of the signal at one or more of the output waveguides may be different from the magnitudes of the optical signals at the other output waveguides. In other embodiments, the splitter network may have a number of outputs that is not equal to a power of two. For example, if the y-splitter that has output waveguides 508g and 508h were to be replaced by a single waveguide, then the splitter network 506a on chip 500 would have seven output waveguides, rather than eight.

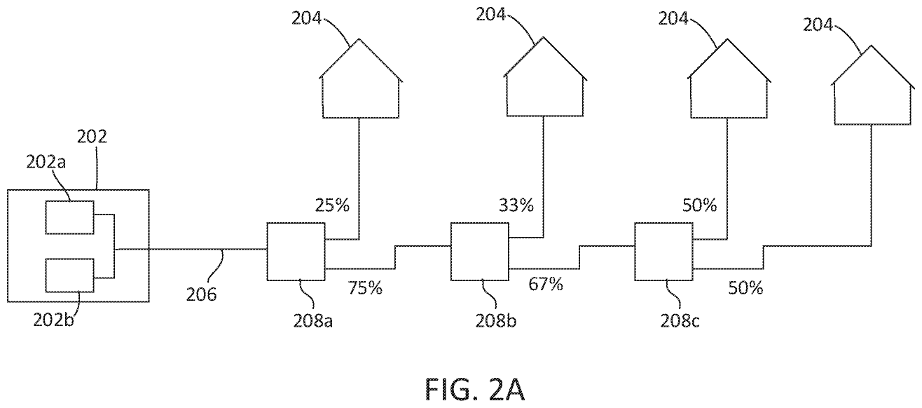

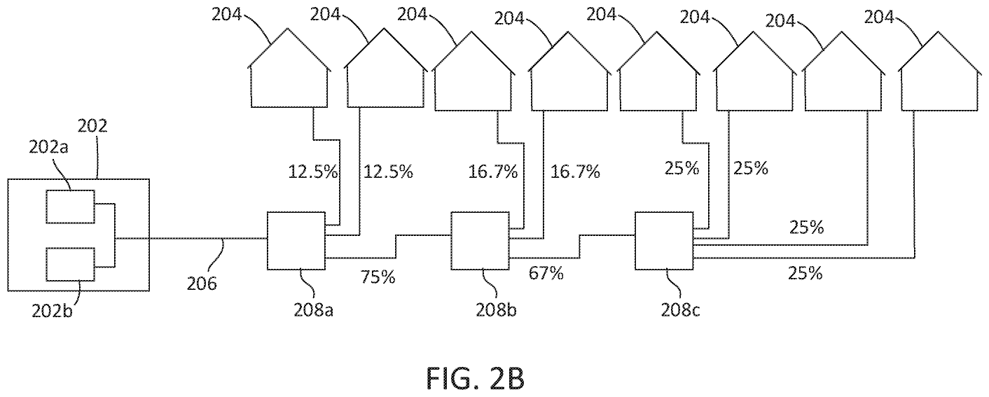

In some embodiments, the waveguide 502 need not act as a bypass but may be used as an input to a second splitter network 506d that has a number of outputs 512b, as illustrated in FIG. 5D. In the illustrated embodiment, the second splitter network 506d is a 1:8 splitter, but it is not restricted to this splitter ratio and can have any other splitter ratio. The splitter ratio of the second splitter network 506d may also be adjustable via dicing the chip 500 in the manner described above with regard to the first splitter network 506a. A chip as shown in FIG. 5D may be useful, for example, close to a branch terminus in an optical communications network. For example, the tap module 208c shown in FIG. 2B contains a splitter network for the tap output and for the main output.

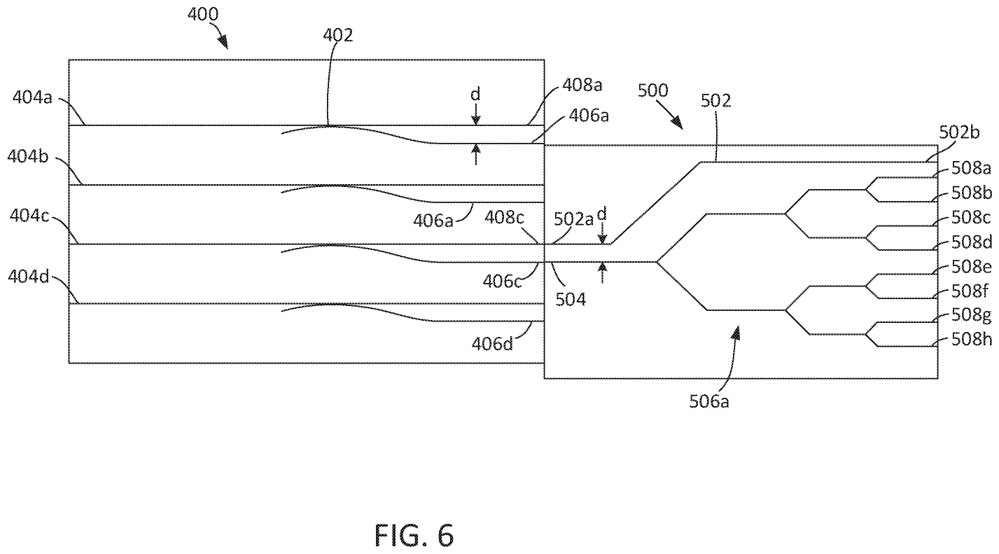

FIG. 6 shows how the chips illustrated in FIGS. 4 and 5A-5C can be employed in the assembly of an optical tap/splitter device having coupled optical chips (a coupled-chip device). The input to the splitter chip 500 can be coupled to any of the outputs from the tap chip 400, so that the tapped optical signal from the tap chip 400 is transmitted to multiple outputs via the splitter assembly 506a, while the main output signal on the main output waveguide of the tap chip 400 is coupled to the bypass waveguide 502 of the splitter chip 500. In this manner, the amount of light propagating along the splitter input waveguide 504 can be selected by coupling the splitter input waveguide 504 to the desired tap output waveguide 406a-406d. In the illustrated arrangement, the input 504 to the splitter assembly 506a is coupled to receive light from the tap output 406c, while the bypass waveguide 502 is coupled to the main output waveguide 408c. For the splitter chip 500 to be mountable to any of the outputs of the tap chip, it is important that the physical distance, d, separating each main output 408a-408d from its respective tap output 406a-406d is the same as the separation distance between the bypass input waveguide 502a and the splitter input waveguide 504.

Because the tap chip 400 has a number of different tap outputs, and because the splitter chip 500 has a number of possible splitter arrangements, it is advantageously possible to manufacture a wide variety of tap/splitter assemblies from a small number of parts.

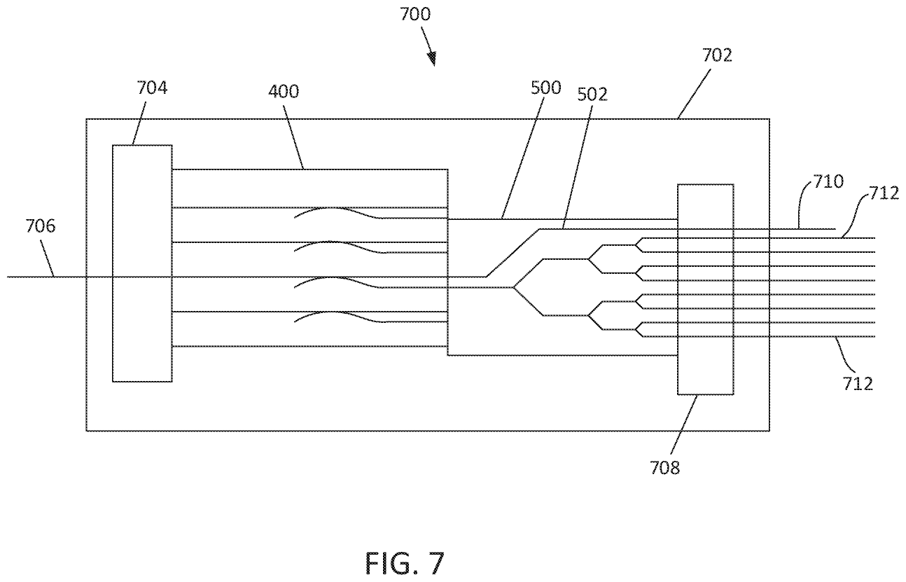

An embodiment of an optical tap/splitter 700 using the coupled tap and splitter chips is schematically illustrated in FIG. 7. The two chips 400, 500 are contained within a housing 702. A first alignment block 704, also within the housing 702, is coupled to the input side of the tap chip 400. The first alignment block 704 may be any suitable type of alignment block, for example using v-grooves or grooves of some other shape. An optical fiber 706, which feeds in from outside the housing 702, is mounted on the first alignment block 704 in alignment with the input waveguide 404c of the tap chip 400. The optical fiber 706 may be, for example, a fiber pigtail.

A second alignment block 708, for example a v-groove block, is located at the output end of the splitter chip 500. A main signal optical fiber 710 is mounted in the second alignment block 708 in alignment with the bypass output waveguide 502b of the splitter chip 500. A number of optical fibers 712 are mounted in the second alignment block 708 in alignment with the splitter chip output waveguides 508a-508h. The main signal optical fiber 710 and the optical fibers 712 may be fiber pigtails.

It will be appreciated that an optical tap/splitter according to the present invention may be different from the embodiments illustrated. For example, the tap chip may include a different number of tap channels that each have a different tap ratio, the splitter chip may be aligned with any one of the tap channels of the tap chip, and the splitter chip may have a different splitter ratio, and hence include more or fewer outputs than those illustrated.

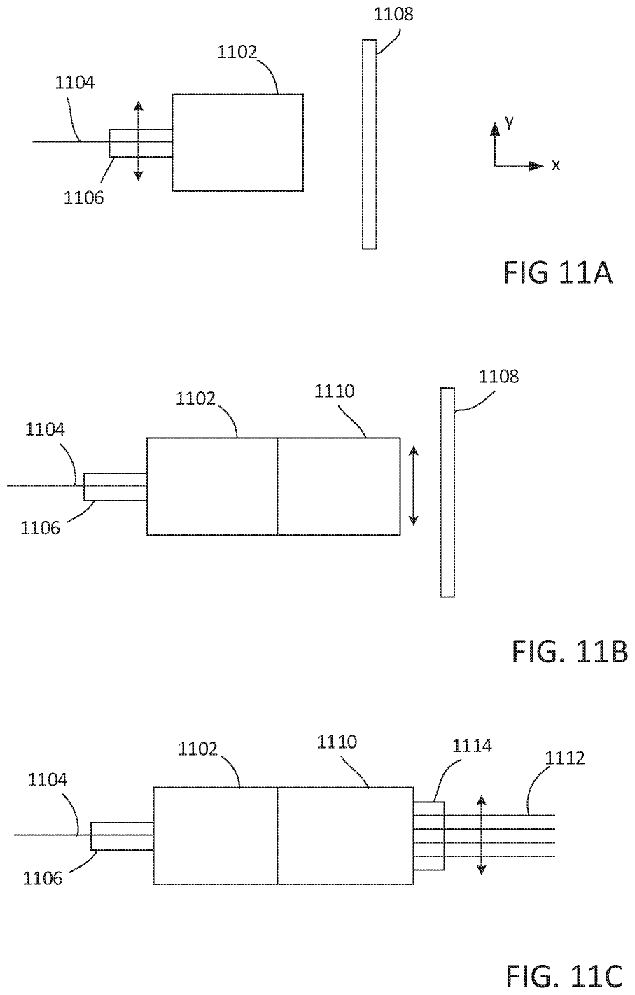

The assembly of the optical components to make the optical tap/splitter 700 may be carried out using standard integrated optical fabrication techniques. One approach is discussed with reference to FIGS. 11A-11C. A first chip 1102 is positioned in a nest or on a vacuum chuck, e.g. by a robotic arm, and its exact position recorded with a vision system. Next, an input fiber 1104 mounted on an alignment block 1106 is positioned in close proximity to the first chip 1102, so that the core of the fiber 1104 is in front of the input waveguide of the first chip 1102, as shown in FIG. 11A. An automated alignment routine is then performed, by moving and rotating the fiber 1104 in the x, y and z dimensions (the z dimension is out of the plane of the illustration). Real-time optimization of the fiber's position may be carried out by injecting an optical signal into the fiber 1104 and detecting the output signal at one or more outputs of the chip 1102 using an optical detector system 1108. The optical signal thus generated may be used as a feedback to align the fiber 1104 to the chip 1102 using a 6-axis precision stage to achieve optimum output power. Once the optimum position is found, an adhesive is applied between the alignment block 1106 and the chip 1102 and UV cured to form a stable bond between the fiber 1104 and the chip 1102.

After alignment with the fiber 1104, a second chip 1110 may be aligned to the output of the first chip 1102 using a similar procedure, as shown in FIG. 11B. Once the second chip 1110 has been aligned to the first chip 1102, they may be bonded via the application of an adhesive between the chips 1102, 1110 and UV curing.

Once the first and second chips 1102, 1110 are mounted together, output fibers 1112 may be aligned to the various outputs of the second chip 1110, as schematically illustrated in FIG. 11C. An alignment block 1114, with fibers 1112 mounted thereto, is positioned in close proximity to the outputs of the second chip 1110. An automated alignment routine is then performed, with feedback provided via monitoring of optical signals received through the fibers 1112, to find the optimum position for the alignment block 1114. Once the optimum position has been found, an adhesive may be applied between the second chip 1110 and the alignment block 1114 and UV cured to secure the alignment block in place relative to the second chip 1110.

It will be appreciated that other procedures may be followed to assemble the components. For example, the adhesive may be applied between components before their relative positions are optimized. In another example, the device may be formed by adding more than just a second ship to the first chip. For example, a third chip may be added to the second chip once the second chip has been mounted to the first chip.

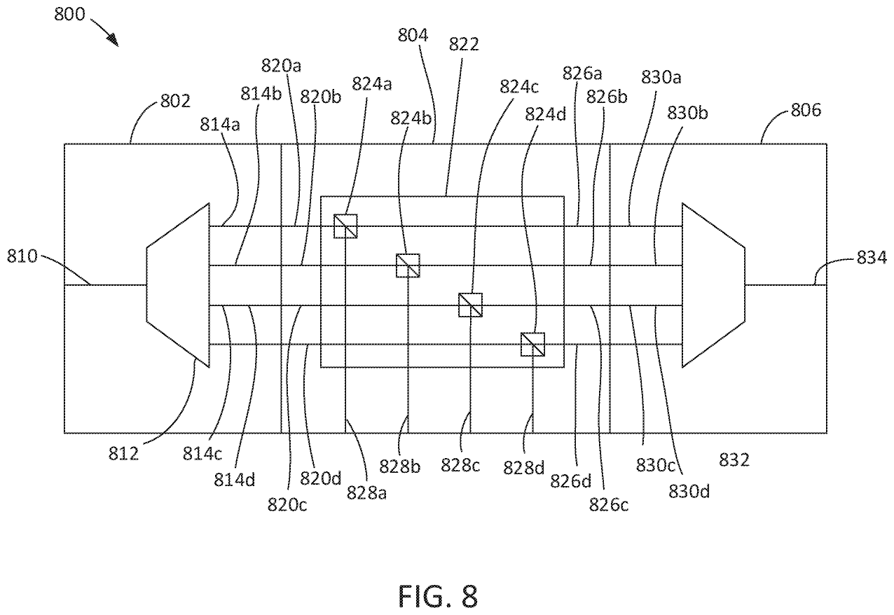

Another embodiment of a coupled-chip optical device 800 is schematically illustrated in FIG. 8. This coupled-chip device 800 includes three optical chips 802, 804, 806 coupled together. One advantage of making an optical device from coupled chips, rather than forming every optical element on a single chip is that optical elements performing one function are advantageously manufactured in a high index contrast optical environment, while optical elements performing another function are advantageously manufactured in a low index contrast optical environment, while it is desired to have both optical functions present in a device. For example, low index contrast platforms are often selected to achieve low propagation loss, low polarization-dependent loss and when it is desired to match the mode field diameter of the waveguide to that of a standard silica fiber. High index platforms may be used when tight bends in a waveguide are used to reduce the size of the optical circuit, e.g. in ring resonators and gratings, thus allowing for compact size and efficient routing. Another advantage, as illustrated with regard to the tap/splitter device discussed above, is that an optical device having a wide variety of operating characteristics can be formed by using only a small number of elements, thus reducing fabrication and inventory costs.

The coupled-chip optical device 800 includes a first chip 802, a second chip 804 and a third chip 806. In this embodiment, the first chip 802 includes an input waveguide 810 coupled to an arrayed waveguide grating (AWG) 812. The AWG 812 separates a wavelength division multiplexed optical signal received from the input waveguide 810 into its different wavelength components, which are directed along single wavelength waveguides 814a-814d that carry respective single wavelength components of the WDM optical signal received by the chip 802 along the input waveguide 810.

The single wavelength waveguides 814a-814d are optically coupled to respective input waveguides 820a-820d on the second chip 804. The second chip 804 includes an optical switch array 822 that includes optical switches 824a-824d coupled to receive optical signals along respective input waveguides 820a-820d. Each optical switch 824a-824d is operable to switch its incoming optical signal between a respective output waveguide 826a-826d, that couples to the third chip 806, and a respective switched output waveguide 828a-828d. When in the bar state an optical switch 824a-824d passes the incoming optical signal on to the output waveguide 826a-826d. If, on the other hand, the optical switch 824a-824d is in the cross state, then the incoming optical signal is directed to the switched output waveguide 828a-828d. The optical switches 824a-824d may be any suitable type of optical waveguide switch, such as electro-optic switches, interferometric switches, totally internally reflecting (TIR) switches, switched couplers, microfluidically activated switches such as electro-wetting on dielectric (EWOD) adiabatic or TIR switches, liquid crystal-based switches, microelectromechanical systems (MEMS) switches, or the like.

The second optical chip 804 is coupled to the third chip 806, so that the output waveguides 826a-826d of the second optical chip 804 are aligned with the input waveguides 830a-830d of the third optical chip 806. The input waveguides 830a-830d connect to a second AWG 832 that combines the signals, at different wavelengths, propagating along the input waveguides 830a-830d into a single WDM optical signal that propagates along the output waveguide 834.

The coupled-chip optical device 800 may be included within a housing, and be provided with connections via fiber pigtails, e.g. to the input waveguide 810, the output waveguide 834 and one or more of the switched output waveguides 828a-828d. The coupled-chip optical device 800 may operate as an add/drop multiplexer, where one or more of the wavelength components of the WDM signal is dropped and directed via the switched output waveguides to a branch network.

It will be appreciated that the coupled-chip optical device 800 may operate in the reverse direction to add a wavelength component to a WDM signal, with optical signals entering the device 800 along waveguide 834 and one or more of waveguides 828a-828d, and leaving along waveguide 810.

In some embodiments, the first and third optical chips 802, 806 are formed in a high index contrast platform, for example using silicon or silicon nitride waveguides, while the switch array 822 of the second optical chip 804 is fabricated using silica waveguides. Thus, the coupled-chip device 800 includes both a high index contrast chip, first and third optical chips 802, 806, and a low index contrast chip 804.

Different types of optical function may be included in a coupled-chip device that uses chips of different index contrast platforms, referred to herein as a hybrid coupled-chip device. For example, certain operations such as dispersive separation, as is found in an AWG, may be implemented in a high index contrast platform and other operations, such as switching, e.g. TIR switching, and optical signal splitting in a y-coupler network may be implemented in a low index contrast network.

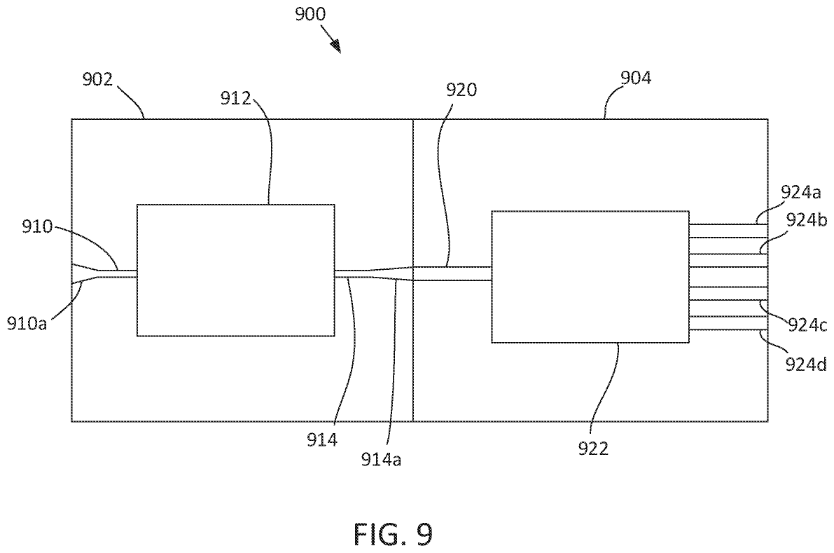

FIG. 9 schematically illustrates a coupled-chip optical device 900 having a first optical chip 902 and a second optical chip 904. The first optical chip 902 is fabricated in a high index contrast platform and includes an input waveguide 910 coupled to a first functional section 912 that operates on the optical signal entering the first optical chip 902. The operation may be any desired optical operation that is suitably enabled in a high index contrast platform.

At least one output waveguide 914 from the first functional section 912 couples to the second optical chip 904. The cross-sectional dimensions of single mode waveguides in the high index contrast chip platform are typically less than those of single mode waveguides fabricated in a low index contrast platform. It is advantageous to maximize the coupling efficiency for light propagating between waveguides fabricated in the two different types of platform. One approach to maximizing coupling efficiency is illustrated in FIG. 9. This approach includes geometrically overlapping the modes of the single mode waveguides by providing a tapered end 914a to the output waveguide 914, so that the mode of the guided wave at the point where the optical signal leaves the first optical chip 902 closely matches that at the input waveguide 920 of the second optical chip. 904. The tapered section 914a may be formed when the waveguide 914 is fabricated, e.g. using standard lithographic techniques. Likewise, a tapered section 910a may be provided at the input waveguide 910 for mode matching between the input waveguide 910 and a single mode optical fiber (not shown) that couples the optical signal to the first chip 902.

The input waveguide 920 transmits light from the first optical chip 902 to the second functional section 922 that operates on the optical signal. The operation may be any desired optical operation that is suitably enabled in a low index contrast platform, such as splitting with a network of y-couplers, switching, and the like. In the illustrated embodiment, four output waveguides 924a-924d transmit respective optical signals from the second functional section 922 to the output of the second chip 904.

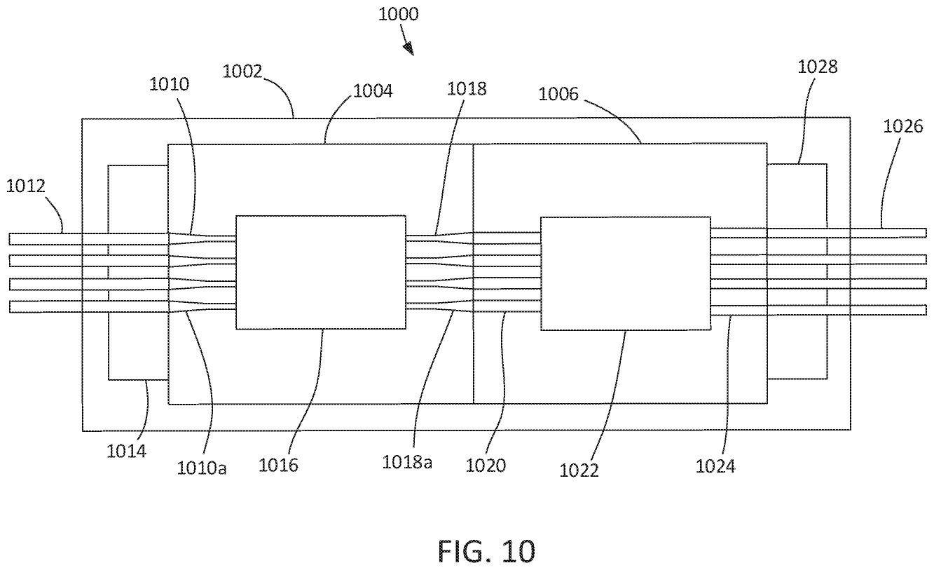

The present invention is not intended to be limited to only the illustrated embodiments, but also many different variations thereof. For example, it is not restricted in the number of optical chips that may be coupled together to provide a coupled-chip optical device. Furthermore, it is not intended to be restricted in the number of input waveguides or output waveguides, nor in the number of input fibers or output fibers that may be coupled to the coupled-chip device. The coupled-chip device may be incorporated within a housing and provided with optical fiber connections, for example optical fiber pigtails. An exemplary embodiment, illustrated in FIG. 10, shows a coupled-chip device 1000 having a housing 1002 that contains a first chip 1004 coupled to a second chip 1006. In this embodiment, the first chip 1004 has four input waveguides 1010. Four input fibers 1012, that pass through the wall of the housing 1002, are mounted to an alignment block 1014 and aligned with the four input waveguides 1010, so that optical signals passing along the four input fibers 1012 are efficiently coupled into the input waveguides 1010. In the illustrated embodiment, the first chip 1004 is fabricated on a high index contrast platform, and so the input waveguides 1010 contain tapered regions 1010a to efficiently couple light from the relatively large optical mode of the input fibers to the relatively small mode of the input waveguides 1010.

The input waveguides 1010 lead to the optical function section 1016 of the first optical chip 1004, which may include any of the functionalities described above. The output waveguides 1018 of the first optical chip 1004 couple from the optical function section 1016 to the second optical chip 1006. The output waveguides 1018 may also include tapered sections 1018a for mode coupling if the input waveguides 1020 of the second optical chip 1006 have a different dimension from that of the output waveguide 1018. The input waveguides 1020 of the second chip 1006 carry signals from the first chip 1004 to the second optical function section 1022, which may include any of the functionalities described above. Output waveguides 1024 from the second optical function section 1022 couple optical signals between the second optical function section 1022 and output fibers 1026. The output fibers 1026 may be mounted in an alignment block 1028 for accurate alignment to the output waveguides 1024. The output fibers 1026 pass through the wall of the housing 1002 and may be fiber pigtails.

The convention adopted in the present description is that light signals enter the device from the left and propagate to the right, in which case waveguides and optical fibers on the left side of a device have been referred to as input waveguides or fibers, and those on the right as output waveguides of fibers. It will be appreciated that many optical devices can operate on light propagating through the device in different directions. For example, an AWG can operate as a wavelength demultiplexer for light signals propagating in one direction through the device and as a wavelength multiplexer for light signals propagating in the opposite direction. Accordingly, although various waveguides and fibers are labeled as “input” and “output” in this description, it should be understood that they are used only for ease of description. The labels “input” and “output” have been used herein for convenience, and it should be understood that the waveguides and optical fibers described herein may carry optical signals in both directions and may operate to input an optical signal to a device and also to output a signal from an optical device.

Various modifications, equivalent processes, as well as numerous structures to which the present invention may be applicable will be readily apparent to those of skill in the art to which the present invention is directed upon review of the present specification. The claims are intended to cover such modifications and devices.

As noted above, the present invention is applicable to fiber optical communication and data transmission systems. Accordingly, the present invention should not be considered limited to the particular examples described above, but rather should be understood to cover all aspects of the invention as fairly set out in the attached claims.

What We claim as the invention is:

1. An optical device, comprising:
a first optical chip having at least a first optical tap and a second optical tap, each optical tap comprising an input waveguide, a main output waveguide and a tap waveguide, the first optical tap having a first tap ratio and the second optical tap having a second tap ratio, the second tap ratio being different from the first tap ratio;
a second optical chip comprising an input waveguide coupled to a waveguide splitter network having a plurality of splitter output waveguides;
wherein the first and second optical chips are coupled together, the input waveguide of the second optical chip being coupled to receive an optical signal from one of the tap waveguides of the first optical chip.

2. An optical device as recited in claim 1, wherein the waveguide splitter network has one of a 1:32, 1:16, 1:8, 1:4 and 1:2 splitter ratio.

3. An optical device as recited in claim 1, further comprising a housing, the first and second optical chips being located within the housing.

4. An optical device as recited in claim 3, further comprising an optical fiber coupled to the input waveguide of the first optical chip and a plurality of optical fibers, optical fibers of the plurality of optical fibers coupled to respective splitter output waveguides.

5. An optical device as recited in claim 4, wherein the optical fiber coupled to the input waveguide of the first chip comprises a fiber pigtail and the plurality of optical fibers comprises a plurality of fiber pigtails.

6. An optical device as recited in claim 1, wherein the first optical chip further comprises at least a third optical tap and a fourth optical tap, the input waveguide of the second optical chip being coupled to receive an optical signal from one of the tap waveguides of the first optical chip.

7. An optical device as recited in claim 1, wherein the second optical chip is diceable such that a splitter ratio of the second optical chip after dicing is different from a splitter ratio of the second optical chip before dicing.

8. An optical device, comprising:
a plurality of optical chips comprising:
a first optical chip having at least a first input waveguide and at least a first output waveguide, and
a second optical chip having at least a second input waveguide and at least a second output waveguide, the at least a second input waveguide of the second optical chip being coupled to receive an optical signal from the at least a first output waveguide of the first optical chip;
wherein one of the first and second optical chips is formed in a high index contrast platform and the other of the first and second optical chips is formed in a low index contrast platform.

9. An optical device as recited in claim 8, wherein the one of the first and second optical chips formed in a high index contrast platform comprises an input waveguide and an output waveguide comprised of at least one of silicon and silicon nitride.

10. An optical device as recited in claim 8, wherein the other of the first and second optical chips formed in a low index contrast platform comprises an input waveguide and an output waveguide comprised of silicon dioxide.

11. An optical device as recited in claim 8, further comprising a third optical chip having at least a third input waveguide and at least a third output waveguide, the at least a third input waveguide of the third optical chip being coupled to receive an optical signal from the at least a second output waveguide of the second optical chip.

12. An optical device as recited in claim 11, wherein the first optical chip comprises a wavelength demultiplexing element optically disposed between the at least a first input waveguide and the at least a first output waveguide, the second optical chip comprises a switch array disposed between the at least a second input waveguide and the at least a second output waveguide, and the third optical chip comprises a wavelength multiplexing element optically disposed between the at least a third input waveguide and the at least a third output waveguide.

13. An optical device as recited in claim 12, wherein the wavelength demultiplexing element of the first chip comprises an arrayed waveguide grating (AWG) and the wavelength multiplexing element of the third chip comprises an AWG.

14. An optical device as recited in claim 8, further comprising a first fiber alignment block attached to the first optical chip and one or more fibers mounted on the first fiber alignment block in alignment with the at least a first input waveguide.

15. An optical device as recited in claim 14, wherein a last optical chip is the optical chip of the plurality of optical chips farthest from the first optical chip, further comprising a second fiber alignment block attached to the last optical chip and one or more fibers mounted on the second fiber alignment block in alignment with one or more output waveguides of the last optical chip.

16. An optical device as recited in claim 15, wherein the one or more fibers mounted on the first fiber alignment block and the one or more fibers mounted on the second fiber alignment block are fiber pigtails.

17. An optical device as recited in claim 15, further comprising a housing containing the plurality of optical chips and the first and second alignment blocks.

18. An optical device as recited in claim 8, wherein the optical chip formed in the high index platform comprises at least one tapered waveguide arranged to couple to the optical chip formed in the low index platform.

19. A method of forming an optical device, comprising:
providing a first optical chip having a plurality of first optical functional elements having different operational characteristics, each first optical functional element having at least a first input waveguide and a first output waveguide;
providing a second optical chip comprising a second optical functional element having at least a second input waveguide and at least a second output;
selecting one of the first optical functional elements of the first optical chip;
aligning the at least a second input waveguide of the second optical chip to the at least a first output waveguide of the selected first optical element; and
mounting the first and second optical chips so as to maintain the alignment of the at least a second input waveguide of the second optical chip to the at least a first output waveguide of the selected first optical element.

20. A method as recited in claim 19, wherein the first optical functional elements are optical taps.

21. A method as recited in claim 19, wherein the second optical functional element is a waveguide splitter network.

22. A method as recited in claim 21, wherein the second optical chip is a 1:M splitter, and further comprising dicing the second optical chip so that the second optical chip becomes a 1:N splitter, where M>N.
